(19) United States
(12) Patent Application Publication
(10) Pub. No.: US 2024/0162941 A1
(43) Pub. Date: May 16, 2024

(54) RECEPTION DEVICE, COMMUNICATION SYSTEM, COMMUNICATION DEVICE AND RECEPTION METHOD

(71) Applicant: NEC Corporation, Tokyo (JP)

(72) Inventor: Sota SUZUKI, Tokyo (JP)

(73) Assignee: NEC Corporation, Tokyo (JP)

(21) Appl. No.: 18/385,202

(22) Filed: Oct. 30, 2023

(30) Foreign Application Priority Data
Nov. 15, 2022 (JP) 2022-182455

(51) Int. Cl. H04B 7/0408; H04B 7/06

(52) U.S. Cl. CPC H04B 7/0408; H04B 7/0602

(57) ABSTRACT

A reception device according to an aspect of the present disclosure includes: a sensor configured to receive a signal from a detection range represented by a range of a reception direction; an actuator configured to change the detection range in such a way that a search direction included in a search range wider than the detection range is included in the detection range for at least a predetermined time; at least one memory storing a set of instructions; and at least one processor configured to execute the set of instructions to: detect reception of the signal; and specify a reception direction in which the signal is received.

This application is based upon and claims the benefit of priority from Japanese Patent Application No. 2022-182455, filed on Nov. 15, 2022, the disclosure of which is incorporated herein in its entirety by reference.

### TECHNICAL FIELD

The present disclosure relates to a signal receiving technique.

### BACKGROUND ART

JP 2001-244893 A describes a communication device that transmits beams in two different operation patterns.

### SUMMARY

An object of the present disclosure is to provide a device for optical communication that achieves weight reduction and cost reduction.

A reception device according to an aspect of the present disclosure includes: a sensor configured to receive a signal from a detection range represented by a range of a reception direction; an actuator configured to change the detection range in such a way that a search direction included in a search range wider than the detection range is included in the detection range for at least a predetermined time; at least one memory storing a set of instructions; and at least one processor configured to execute the set of instructions to: detect reception of the signal; and specify a reception direction in which the signal is received.

A communication device according to an aspect of the present disclosure includes: a sensor configured to receive a signal from a detection range represented by a range of a detection direction; an actuator configured to change the detection range in such a way that a search direction included in a search range is included in the detection range for at least a predetermined time, the search range being wider than the detection range; at least one memory storing a set of instructions; at least one processor configured to execute the set of instructions to specify a reception direction in which the signal is received; a transmitter configured to transmit a second signal toward a transmission range of a predetermined size, the transmission range represented by a range of transmission direction; and a second actuator configured to change the transmission range in such a way that a scan direction included in a scan range is included in the transmission range for at least a second predetermined time, the scan range being wider than the transmission range.

A reception method according to an aspect of the present disclosure includes: receiving a signal from a detection range represented by a range of a reception direction; changing the detection range in such a way that a search direction included in a search range wider than the detection range is included in the detection range for at least a predetermined time; detecting reception of the signal; and specifying a reception direction in which the signal is received.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of a reception device according to a first example embodiment of the present disclosure;

FIG. 2 is a block diagram illustrating an example of operation of a reception device 10 according to the first example embodiment of the present disclosure;

FIG. 3 is a diagram illustrating an example of a case where signal light does not enter a field of view of a sensor unit;

FIG. 4 is a diagram schematically illustrating movement of the field of view of the sensor unit;

FIG. 5 is a diagram illustrating an example of arrangement of a plurality of target ranges;

FIG. 6 is a diagram illustrating an example of arrangement of a plurality of target ranges;

FIG. 7 is a diagram illustrating an example of arrangement of a plurality of target ranges;

FIG. 8 is a diagram illustrating an example of arrangement of a plurality of target ranges;

FIG. 9 is a diagram schematically illustrating a second example of a driving method;

FIG. 10 is a block diagram illustrating an example of a configuration of a communication system according to a second example embodiment of the present disclosure;

FIG. 11 is a flowchart illustrating an example of the operation of the reception device according to the second example embodiment of the present disclosure;

FIG. 12 is a block diagram illustrating an example of a configuration of a communication device according to a second modification of the second example embodiment of the present disclosure;

FIG. 13 is a block diagram illustrating an example of a configuration of a communication system according to the second modification of the second example embodiment of the present disclosure; and

FIG. 14 is a diagram illustrating an example of a hardware configuration of a computer that can implement the reception device, the transmission device, and the communication device according to the example embodiment of the present disclosure.

### EXAMPLE EMBODIMENT

Hereinafter, example embodiments of the present disclosure will be described in detail with reference to the drawings.

### First Example Embodiment

First, a first example embodiment of the present disclosure will be described in detail with reference to the drawings.

<Configuration>

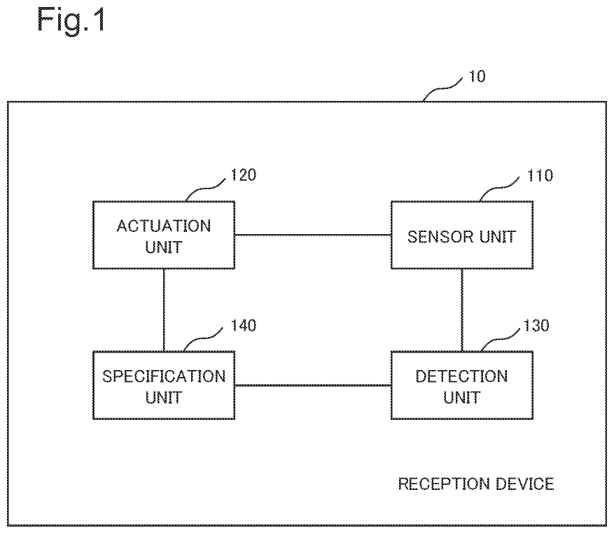

FIG. 1 is a block diagram illustrating an example of a configuration of a reception device according to the first example embodiment of the present disclosure. In the example illustrated in FIG. 1, a reception device according to the first example embodiment of the present disclosure includes a sensor unit 110, an actuation unit 120, a detection unit 130, and a specification unit 140. The sensor unit 110 receives a signal from a detection range represented by a range of a direction. The actuation unit 120 changes the detection range such that a direction included in a search range wider than the detection range is included in the detection range for at least a predetermined time. The detection unit 130 detects that the signal has been received. The specification unit 140 specifies a direction in which the signal is received. In the following description, the signal is a signal by light, that is, signal light. The signal light is light having a predetermined wavelength. Hereinafter, the signal is also referred to as signal light. The signal light is transmitted from a transmission device that communicates with the reception device 10. The signal light is signal light for specifying a direction of a communication partner different from the signal light for communication.

<Sensor Unit 110>

The sensor unit 110 is an optical sensor that outputs a signal indicating that the signal light has been received, for example, when the signal light reaches from a direction included in the detection range.

In general, the sensor unit 110 can receive signal light from the above-described field of view, that is, a range having a certain spread (that is, the range of a direction). The detection range is a range in which the sensor unit 110 mounted on the reception device 10 can receive signal light. The detection range is a range, having a solid angle of a predetermined size, of a direction. For example, a range within a predetermined angle (hereinafter, also referred to as a detection angle) from the center direction of the detection range of the sensor unit 110 (for example, the direction in which the sensor unit 110 faces) is the detection range. The direction in which the sensor unit 110 faces is referred to as a detection direction. In this case, the sensor unit 110 can receive signal light arriving from a direction the angle of which from the detection direction is within the detection angle. The actuation unit 120 described in detail later can change the detection range.

<Actuation Unit 120>

As described above, the actuation unit 120 changes the detection range so that the direction included in the search range wider than the detection range is included in the detection range for at least a predetermined time. The search range is a range, having a solid angle of a predetermined size, of a direction. The size of the solid angle of the search range is larger than the size of the solid angle of the detection range. In the present example embodiment, the search range is given to the actuation unit 120 in advance. The present example embodiment is configured in such a way that the signal light incident on the sensor unit 110 is incident on the sensor unit 110 via one or more mirrors. The actuation unit 120 changes the direction of the signal light incident on the sensor unit 110, for example, by controlling the direction of the mirror. The actuation unit 120 changes the detection range by changing the direction of the signal light incident on the sensor unit 110 using a mirror. The actuation unit 120 may be configured to change the direction of the sensor unit 110 instead of the direction of the mirror.

A method of changing the detection range by the actuation unit 120 (hereinafter, referred to as an actuation method), in other words, a pattern of changing the detection range will be described in detail later.

<Detection Unit 130>

Specifically, the detection unit 130 receives a signal from the sensor unit 110. Then, the detection unit 130 detects whether the sensor unit 110 receives signal light from the signal from the sensor unit 110. For example, in a case where the sensor unit 110 outputs a signal indicating that the signal light has been received, the detection unit 130 detects that the sensor unit 110 has received the signal light. For example, in a case where the sensor unit 110 does not output a signal indicating that the signal light is received, the detection unit 130 detects that the sensor unit 110 does not receive the signal light.

When detecting that the signal light is received, the detection unit 130 may transmit information indicating that the signal light is detected to the specification unit 140. The detection unit 130 may transmit information indicating that the signal light is not detected to the specification unit 140 while the reception of the signal light is not detected.

<Specification Unit 140>

When the sensor unit 110 detects the signal light, the specification unit 140 specifies the direction of the detected signal light. Specifically, the specification unit 140 receives information indicating that the signal light is detected from the detection unit 130. When receiving the information indicating that the signal light is detected from the detection unit 130, the specification unit 140 receives the information indicating the direction in which the detection range of the sensor unit 110 is directed by the actuation unit 120 from the actuation unit 120. The specification unit 140 sets the received information as information indicating a direction in which the signal light is received when the sensor unit 110 detects the signal light. The direction in which the detection range is directed is, for example, the above-described detection direction.

For example, it is assumed that the sensor unit 110 and the communication optical sensor are mounted on the reception device 10 such that the direction of the sensor unit 110 and the direction of the communication optical sensor performing optical communication are the same, and the size of the field of view of the communication optical sensor is equal to or larger than the size of the field of view of the sensor unit 110. In that case, if the sensor unit 110 is directed in the direction in which the signal light can be received, the communication optical sensor can also receive the optical communication signal light. Therefore, if the direction of the signal light is included in the detection range, the specification unit 140 may determine that the detection direction is the direction of the detected signal light.

<Operation>

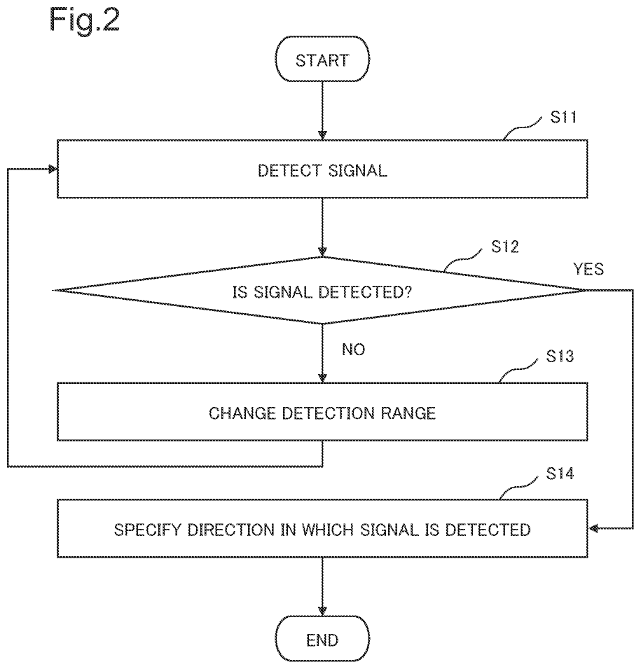

FIG. 2 is a block diagram illustrating an example of operation of the reception device 10 according to the first example embodiment of the present disclosure. In the example illustrated in FIG. 2, the detection unit 130 detects a signal (step S11). Specifically, the detection unit 130 detects whether the sensor unit 110 has received signal light from the detection range, that is, signal light arriving from a direction included in the detection range.

When no signal is detected (NO in step S12), the actuation unit 120 changes the detection range (step S13). Then, the reception device 10 repeats the operations in and after step S11.

When a signal is detected (YES in step S12), the specification unit 140 specifies a direction in which the signal is detected (step S14). For example, the specification unit 140 specifies a direction in which the detection range is directed when the signal is detected, that is, the detection direction.

### Effects

The present example embodiment has an effect of achieving weight reduction and cost reduction of a device for optical communication.

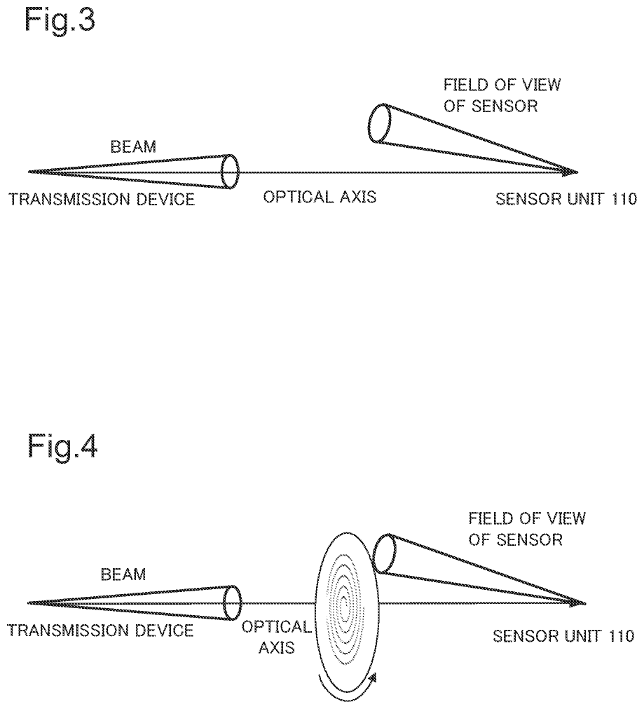

FIG. 3 is a diagram illustrating an example of a case where the signal light (that is, the beam) is not included in the field of view of the sensor unit 110. In an initial stage of capture of the transmission device (in other words, capture of signal light from the transmission device), as in the example illustrated in FIG. 3, there is a case where the direction of the transmission unit on the transmission side does not enter the field of view of the sensor unit 110 on the reception side. In this case, the sensor unit 110 is not able to receive a beam of signal light.

FIG. 4 is a diagram schematically illustrating movement of the field of view of the sensor unit 110. In this manner, by moving (that is, changing) the field of view of the sensor unit 110, the field of view of the sensor unit 110 having a narrow field of view can be virtually widened. Then, it is possible to increase the possibility that the sensor unit 110 receives signal light (that is, the beam).

In this manner, the actuation unit 120 changes the detection range, the detection unit 130 detects that the signal light is received, and the specification unit 140 specifies the direction of the detection direction when the signal light is received, whereby the direction of the transmission device can be specified. As a result, in order to specify the direction of the transmission device, it is not necessary to mount another sensor having a field of view wider than the field of view of the sensor unit 110 on the reception device 10 in addition to the sensor unit 110. Therefore, the present example embodiment has an effect of achieving weight reduction and cost reduction of a device for optical communication.

### First Example of Actuation Method

The actuation unit 120 may move the detection range so that the detection range coincides with each of a plurality of target ranges set to overlap the search range. In this case, the shape of each of the target ranges projected onto the surface of a sphere having a predetermined radius is the same as the shape of the detection range projected onto the surface of the same sphere. The plurality of target ranges are set such that a direction included in the search range is included in at least one of the plurality of target ranges. In other words, the plurality of target ranges are set such that any portion of the search range is included in at least one of the plurality of target ranges. In other words, the plurality of target ranges are set such that the minimum range including the plurality of target ranges includes the search range.

The actuation unit 120 may change the target range such that the detection range is directed to each of the plurality of target ranges in a predetermined order, for example. In this case, the order in which the detection range is directed may be determined such that the order in which the detection range is directed becomes earlier as the directed detection range becomes closer to the center of the search range, for example. The order in which the detection range is directed may be determined such that movement of the detection range while the detection range is directed to each of the target ranges causes the smallest sum of the angles at which the detection range moves. The order in which the detection range is directed may be determined according to another rule. The order in which the detection range is directed may be randomly determined.

The actuation unit 120 may be configured to direct the detection range toward the next target range after a predetermined time (or longer than or equal to a predetermined time) has elapsed since the detection range has been directed toward one target range. As described in the following description of the example embodiment, when the signal light is detected, the actuation unit 120 may temporarily end the operation of directing the detection range to the plurality of target ranges even if the detection range is not directed to all of the plurality of target ranges. In this case, the actuation unit 120 receives information indicating whether signal light is detected, for example, from the specification unit 140. The specification unit 140 is configured to send information indicating whether signal light is detected to the actuation unit 120. Then, for example, the actuation unit 120 may set the center direction (that is, the target direction) of the target range toward which the detection range has been directed when the signal light is detected as the center direction (also referred to as a search direction) of the next search range. Then, the actuation unit 120 may start an operation of directing the detection range to each of the plurality of target ranges determined for the new search range.

In a case where the signal light is not detected even when the detection range is directed to all of the plurality of target ranges, the actuation unit 120 may again direct the detection range to the target range in the first order. Then, the actuation unit 120 may repeat the operation of directing the detection range to each of the plurality of target ranges from the beginning again.

A target direction that is a direction of the center of each target range (the center of gravity of the target range in a case where the target range is not circular) may be determined. Then, the actuation unit 120 may be configured to move the detection range such that the detection direction, which is the direction of the center of the detection range (the center of gravity of the target range when the detection range is not circular), is directed to each of the plurality of target directions.

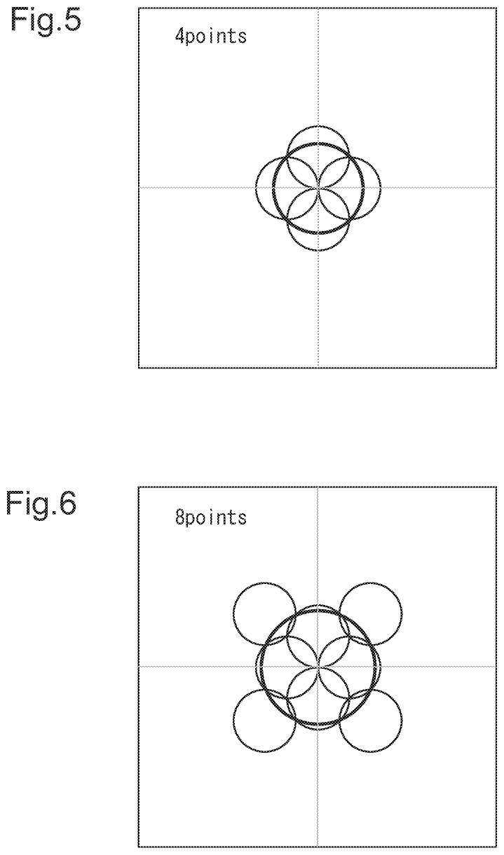

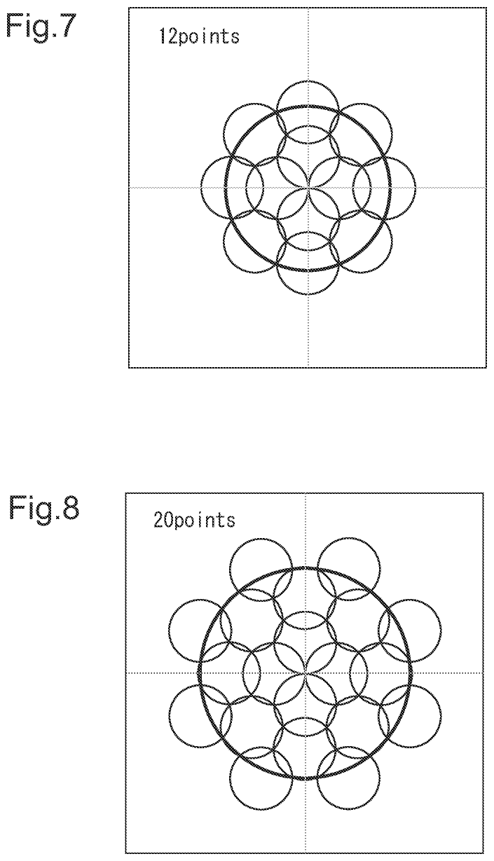

FIGS. 5 to 8 are diagrams illustrating examples of arrangement of a plurality of target ranges. In these drawings, circles drawn by thick lines represent the search range. A circle drawn by a thin line represents the target range. As in these examples, the arrangement of the plurality of detection ranges may be determined according to a difference in size between the search range and the target range.

The actuation unit 120 may determine the size of the next search range such that the size of the next search range increases as the angle between the direction of the detection range at the time when the signal light is detected latest and the direction of the detection range at the time when the signal light is detected previously increases.

For example, when the direction of the detection range at the time when the signal light is detected last time is the center of the next search range, the actuation unit 120 may determine the next search range such that the next search range includes the direction of the detection range at the time when the latest signal light is detected. In this case, the actuation unit 120 may determine the plurality of target ranges according to, for example, a predetermined rule such that the direction included in the determined next search range is included in at least one of the plurality of target ranges. For example, the actuation unit 120 may select an arrangement in which a direction included in the determined next search range is included in at least one of the plurality of target ranges from the arrangements of the plurality of detection ranges as illustrated in FIGS. 5 to 8. For example, when the direction of the detection range at the time when the previous signal light is detected is the center of the search range, the actuation unit 120 may select, as the next search range from a plurality of predetermined search ranges, a search range including the direction of the detection range at the time when the latest signal light is detected.

The actuation unit 120 moves the detection range between two detection ranges in a time shorter than a time for directing the detection range to one detection range. The time for directing the detection range to one detection range may be, for example, about 10 seconds to several tens of seconds. The time for moving the detection range between the two detection ranges may be, for example, about 0.01 seconds. The time for moving the detection range between the two detection ranges may be, for example, less than 0.01 seconds. The time for moving the detection range between the two detection ranges is not limited to these examples.

In the following description, a method of changing the detection range in the first example of the actuation method is also referred to as point pattern actuation.

In the point pattern actuation, the arrangement of the plurality of target ranges may be randomly set.

### Second Example of Actuation Method

The actuation unit 120 may change the detection range so that the detection range moves toward the outside of the search range with a spiral movement from the direction of the center of the search range. In this case, the actuation unit 120 directs the direction (that is, the detection direction) of the center of the detection range to a predetermined direction (hereinafter, also referred to as starting point direction) within the search range. The starting point direction may not be the direction of the center of the search range. The starting point direction may be a direction of the center of the search range. Then, the actuation unit 120 changes the detection range so that a plane including the straight line in the starting point direction and the straight line in the detection direction rotates in a constant direction on an axis that is the straight line in the starting point direction while increasing the degree of angle between the starting point direction and the detection direction (that is, the detection direction is changed). At that time, the actuation unit 120 may change the detection range (that is, may change the detection direction) so that the magnitude of the change of the detection direction is constant. The magnitude of the change of the detection direction is not necessarily constant.

The movement of the detection direction is determined in advance such that the direction included in the search range is included in the detection range for at least a predetermined time (for example, 10 seconds to several tens of seconds). The predetermined time is not limited to the above example. The movement of the detection direction may be determined, for example, as a function with a variable of time, which indicates a three-dimensional vector representing the detection direction in a coordinate system defined in a three-dimensional space. The movement may be defined as a function with a variable of time, which indicates the angle between the search direction and the detection direction, and may be defined as a function with a variable of time, which indicates the intersection line between the plane perpendicular to the search direction and the plane including the straight line in the starting point direction and the straight line in the detection direction in a coordinate system defined on the plane perpendicular to the search direction.

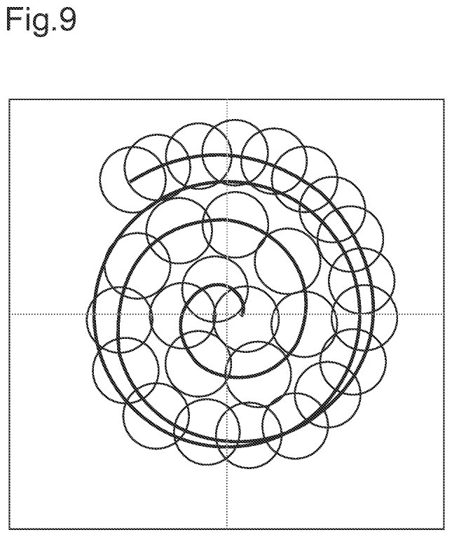

FIG. 9 is a diagram schematically illustrating a second example of the actuation method. In FIG. 9, a circle drawn by a thick line represent the search range. A plurality of circles drawn by thin lines represent the detection ranges at a plurality of time points in the course of the change of the detection range. The positions of the detection ranges depicted in FIG. 9 are not necessarily detection ranges at a plurality of time points at identical time intervals. A spiral line in FIG. 9 represents a change, with the elapse of time, of a direction in which the detection direction is directed.

In the following description, a method of changing the detection range in the second example of the actuation method is also referred to as spiral actuation.

In a case where the signal light is detected, the actuation unit 120 may temporarily end the change of the detection range by the spiral actuation at a time point when the signal light is detected, and may set the direction of the detection range (that is, the detection direction) at the time when the signal light is detected as the direction of the center of the next search range (that is, the search direction). In this case, the actuation unit 120 receives information indicating whether signal light is detected, for example, from the specification unit 140. The specification unit 140 is configured to send information indicating whether signal light is detected to the actuation unit 120. Then, the actuation unit 120 may start a change of the detection range by spiral actuation for the next search range.

### Third Example of Actuation Method

The actuation unit 120 may change the detection range by the above-described point pattern actuation in a first search range which has the same center direction as the center direction of the search range and is narrower than the search range. Then, in a second search range that is a range included in the search range and not included in the first search range, the detection range may be changed by the spiral actuation described above. The direction (that is, the direction in which the actuation unit 120 starts the change of the detection range by the spiral actuation) of the starting point of the spiral actuation in this example is a predetermined direction different from the center of the search range.

In the following description, a method of changing the detection range in the third example of the actuation method is also referred to as hybrid actuation.

In a case where the signal light is detected, the actuation unit 120 may temporarily end the change of the detection range by the hybrid actuation at a time point when the signal light is detected, and may set the direction of the detection range (that is, the detection direction) at the time when the signal light is detected as the direction of the center of the next search range (that is, the search direction). In this case, the actuation unit 120 receives information indicating whether signal light is detected, for example, from the specification unit 140. The specification unit 140 is configured to send information indicating whether signal light detected to the actuation unit 120. Then, the actuation unit 120 may start a change of the detection range by the hybrid actuation with respect to the next search range.

### Second Example Embodiment

Next, a second example embodiment of the present disclosure will be described in detail with reference to the drawings.

<Configuration>

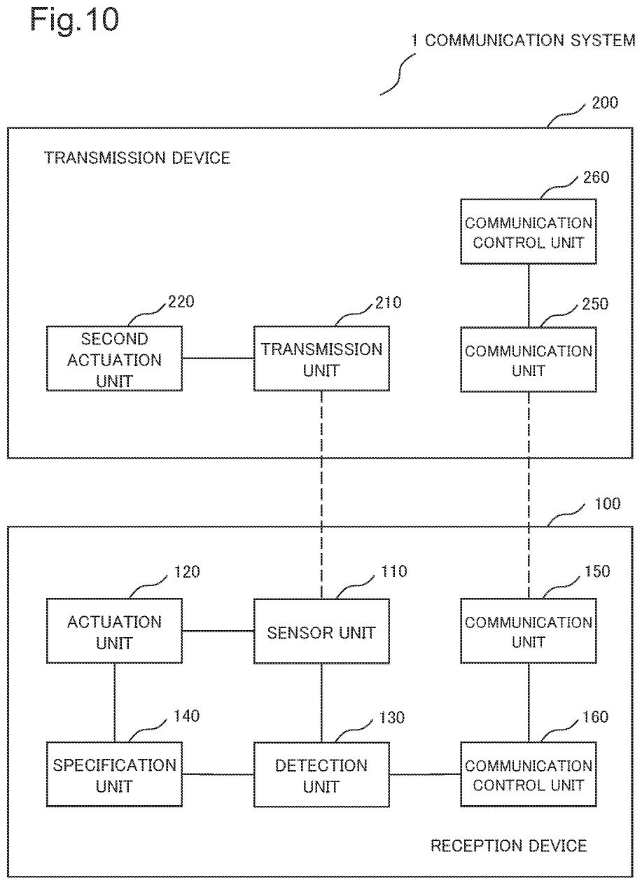

FIG. 10 is a block diagram illustrating an example of a configuration of a communication system according to the second example embodiment of the present disclosure. In the example illustrated in FIG. 10, a communication system 1 according to the present example embodiment includes a reception device 100 and a transmission device 200. The transmission device 200 of the present example embodiment is relevant to the transmission device of the first example embodiment.

<Reception Device 100>

The reception device 100 includes a sensor unit 110, an actuation unit 120, a detection unit 130, a specification unit 140, a communication unit 150, and a communication control unit 160. The sensor unit 110, the actuation unit 120, the detection unit 130, and the specification unit 140 of the present example embodiment are the same as the sensor unit 110, the actuation unit 120, the detection unit 130, and the specification unit 140 of the first example embodiment, except for differences described below. The sensor unit 110, the actuation unit 120, the detection unit 130, and the specification unit 140 of the present example embodiment operate similarly to the sensor unit 110, the actuation unit 120, the detection unit 130, and the specification unit 140 of the first example embodiment, except for differences described below.

<Actuation Unit 120>

As described in the first example of the actuation method, when the signal light is detected, the actuation unit 120 of the present example embodiment temporarily ends the operation of directing the detection range to the plurality of target ranges even if the detection range is not directed to all of the plurality of target ranges. In this case, the actuation unit 120 receives information indicating whether signal light is detected, for example, from the specification unit 140. As described later, the specification unit 140 is configured to send information indicating whether signal light is detected to the actuation unit 120. Then, for example, the actuation unit 120 sets the center direction (that is, the target direction) of the target range to which the detection range has been directed when the signal light is detected as the center direction (also referred to as a search direction) of the next search range. Then, the actuation unit 120 starts an operation of directing the detection range to each of a plurality of target ranges determined for the new search range. The method of changing the detection range, that is, the actuation method may be any of the point pattern actuation, the spiral actuation, and the hybrid actuation described above.

<Detection Unit 130>

The detection unit 130 further transmits information indicating whether the sensor unit 110 has received signal light to the communication control unit 160. Specifically, while detecting the sensor unit 110 receiving the signal light, the detection unit 130 sends information indicating that the signal light is detected to the communication control unit 160. While not detecting the sensor unit 110 receiving the signal light, the detection unit 130 sends information indicating that signal light is not detected to the communication control unit 160.

<Specification Unit 140>

In the present example embodiment, the specification unit 140 further sends information indicating whether signal light is detected to the actuation unit 120.

<Communication Unit 150>

The communication unit 150 performs optical communication with the transmission device 200 that transmits signal light under the control of the communication control unit 160 described later in detail. The signal light for optical communication is different from the signal light received by the sensor unit 110. In the present invention, the signal light for optical communication is also referred to as optical communication signal light.

The communication unit 150 receives information transmitted to the transmission device 200 by optical communication from the communication control unit 160. The communication unit 150 sends the information received from the transmission device 200 by optical communication to the communication control unit 160.

<Communication Control Unit 160>

The communication control unit 160 receives, from the detection unit 130, information indicating whether the sensor unit 110 receives signal light. While the received information indicates that the sensor unit 110 is receiving signal light, the communication control unit 160 controls the communication unit 150 to communicate with the transmission device 200 that has transmitted the signal light.

The communication control unit 160 may receive the information transmitted by the communication unit 150 via optical communication from another communication unit included in the reception device 100, an observation device mounted on the reception device 100, or the like. The communication control unit 160 sends information transmitted by the communication unit 150 through communication to the communication unit 150.

The communication control unit 160 receives information received by the communication unit 150 via optical communication from the communication unit 150. The communication control unit 160 may control another communication unit to transmit the information received from the communication unit 150 to another communication device via another communication unit, for example.

The reception device 100 of the present example embodiment receive and transmit signal light for optical communication by the communication control unit 160 and the communication unit 150 as described above.

<Transmission Device 200>

The transmission device 200 includes a transmission unit 210, a second actuation unit 220, a communication unit 250, and a communication control unit 260.

<Transmission Unit 210>

The transmission unit 210 transmits signal light. The transmission unit 210 is achieved by a light source such as a laser that generates signal light having a predetermined wavelength. The transmission unit 210 transmits the signal light toward a transmission range of a predetermined size, which is represented by a range of a direction.

<Second Actuation Unit 220>

The second actuation unit 220 changes the direction of the signal light transmitted by the transmission unit 210. For example, the second actuation unit 220 changes the transmission range such that the direction included in the scanning range wider than the transmission range is included in the transmission range for at least a predetermined second time.

The method by which the second actuation unit 220 changes the transmission range may be a method similar to the point pattern actuation described above. The method by which the second actuation unit 220 changes the transmission range may be a method similar to the spiral actuation described above. The method by which the second actuation unit 220 changes the transmission range may be a method similar to the hybrid actuation described above. In these cases, the second actuation unit 220 changes the transmission range such that the transmission range changes similarly to the change of the transmission range in a case where the detection range is replaced with the transmission range and the search range is replaced with the scanning range in the above description of the point pattern actuation, the spiral actuation, and the hybrid actuation. However, in the present example embodiment, the second actuation unit 220 repeatedly performs the operation of changing the transmission range without interruption (corresponds to the above-described temporary ending).

In the present example embodiment, the second actuation unit 220 acquires the direction of the reception device 100 in advance. The positional relationship between the transmission device 200 and the reception device 100 can change at all times. Therefore, the direction of the reception device 100 acquired in advance is not necessarily accurate. The second actuation unit 220 sets the direction of the reception device 100 acquired in advance as the direction of the center of the scanning range.

The predetermined second time is a time shorter than the above-described predetermined time during which a direction included in a search range wider than the detection range is included in the detection range.

<Communication Unit 250>

The communication unit 250 performs optical communication with the reception device 100 that transmits signal light under the control of the communication control unit 260 described later in detail. The signal light for optical communication is different from the signal light transmitted by the transmission unit 210. The signal light for optical communication is the above-described optical communication signal light.

The communication unit 250 receives, from the communication control unit 260, information transmitted to the reception device 100 by optical communication. The communication unit 150 sends the information received from the reception device 100 by optical communication to the communication control unit 260.

<Communication Control Unit 260>

The communication control unit 260 controls the communication unit 250 to communicate with the reception device 100.

The communication control unit 260 may receive the information transmitted by the communication unit 250 via optical communication from another communication unit included in the transmission device 200, an observation device mounted on the transmission device 200, or the like. The communication control unit 260 sends information transmitted by the communication unit 250 through communication to the communication unit 250.

The communication control unit 260 receives information received by the communication unit 250 through optical communication from the communication unit 250. The communication control unit 260 may control another communication unit to transmit the information received from the communication unit 250 to another communication device via another communication unit, for example.

The transmission device 200 of the present example embodiment receive and transmit signal light for optical communication by the communication control unit 260 and the communication unit 250 as described above.

<Operation>

Next, an operation of the reception device 100 according to the second example embodiment of the present disclosure will be described in detail with reference to the drawings.

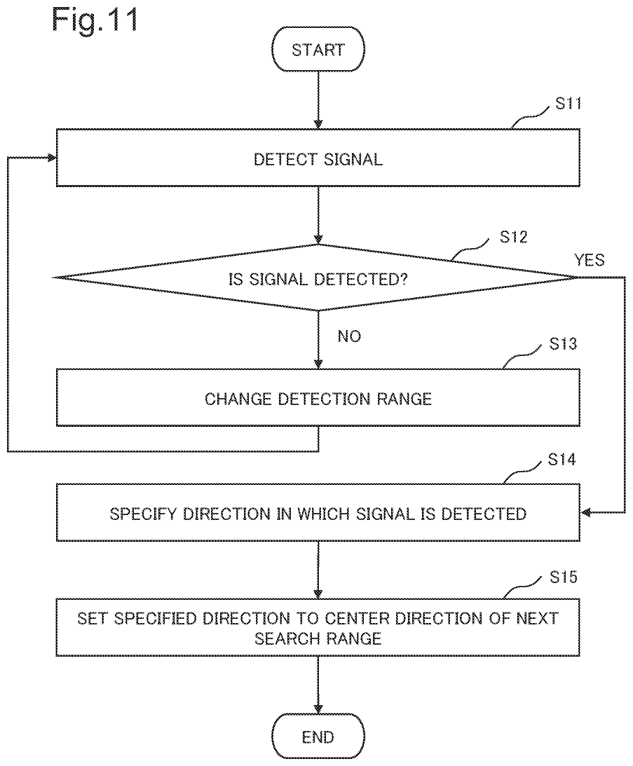

FIG. 11 is a flowchart illustrating an example of the operation of the reception device 100 according to the second example embodiment of the present disclosure. In the example illustrated in FIG. 11, the detection unit 130 detects a signal (step S11). Specifically, the detection unit 130 detects whether the sensor unit 110 receives signal light from the detection range, that is, signal light arriving from a direction included in the detection range.

When no signal is detected (NO in step S12), the actuation unit 120 changes the detection range (step S13). Then, the reception device 10 repeats the operations in and after step S11.

When a signal is detected (YES in step S12), the specification unit 140 specifies a direction in which the signal is detected (step S14). For example, the specification unit 140 specifies a direction, that is, the detection direction, in which the detection range is directed when the signal is detected. Then, the actuation unit 120 sets the specified direction as the center direction of the next search range (step S15).

Then, the reception device 100 repeats the operation illustrated in FIG. 11.

### Effects

The present example embodiment has the same effect as the effect of the first example embodiment. The reason why the effect of the present example embodiment is produced is the same as the reason why the effect of the first example embodiment is produced.

### First Modification of Second Example Embodiment

In a first modification of the second example embodiment of the present disclosure, the reception device 100 is the same as the reception device 100 of the second example embodiment. The configuration of the transmission device 200 is the same as the configuration of the transmission device 200 of the second example embodiment. The transmission device 200 in the present example embodiment is the same as the transmission device 200 in the second example embodiment except for the following differences.

The second actuation unit 220 of the present modification directs the center, received in advance, of the transmission range toward the reception device 100. However, in the present modification, the second actuation unit 220 does not change the transmission range using methods such as point pattern actuation, spiral actuation, and hybrid actuation.

### Second Modification of Second Example Embodiment

The above-described description of the second example embodiment describes the configuration in which the reception device 100 does not include the transmission unit 210 and the second actuation unit, and the transmission device 200 does not include the sensor unit 110, the actuation unit 120, the detection unit 130, and the specification unit 140. However, the reception device 100 may further include the transmission unit 210 and the second actuation unit. The transmission device 200 may further include the sensor unit 110, the actuation unit 120, the detection unit 130, and the specification unit 140. The reception device 100 further including the transmission unit 210 and the second actuation unit, and the transmission device 200 further including the sensor unit 110, the actuation unit 120, the detection unit 130, and the specification unit 140 have similar configurations. In the present modification, the reception device 100 further including the transmission unit 210 and the second actuation unit, and the transmission device 200 further including the sensor unit 110, the actuation unit 120, the detection unit 130, and the specification unit 140 are collectively referred to as a communication device 300.

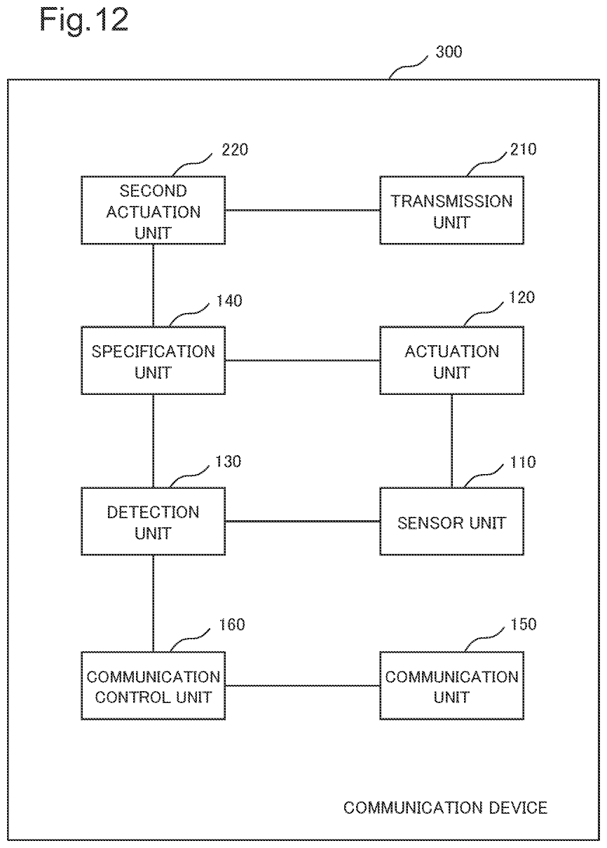

FIG. 12 is a block diagram illustrating an example of a configuration of the communication device 300 according to the second modification of the second example embodiment of the present disclosure. In the example illustrated in FIG. 12, the communication device 300 includes a sensor unit 110, an actuation unit 120, a detection unit 130, a specification unit 140, a communication unit 150, a communication control unit 160, a transmission unit 210, and a second actuation unit 220. The sensor unit 110, the actuation unit 120, the detection unit 130, the specification unit 140, the communication unit 150, the communication control unit 160, the transmission unit 210, and the second actuation unit 220 of the present modification are similar to the sensor unit 110, the actuation unit 120, the detection unit 130, the specification unit 140, the communication unit 150, the communication control unit 160, the transmission unit 210, and the second actuation unit 220 of the second example embodiment except for the following differences.

The description of the elements included in the reception device 100 of the second example embodiment of the communication device 300 of the present modification corresponds to the description in which the reception device 100 is replaced with the communication device 300 and the transmission device 200 is replaced with another communication device 300 in the description of the second example embodiment. The description of the elements included in the transmission device 200 of the second example embodiment of the communication device 300 of the present modification corresponds to the description in which the transmission device 200 is replaced with the communication device 300 including those elements and the reception device 100 is replaced with another communication device 300 in the description of the second example embodiment. The transmission device 200 corresponds to another communication device 300.

<Specification Unit 140>

The specification unit 140 transmits information indicating the direction in which the signal light is received, that is, the detection direction at the time when detecting the signal light being received, to the second actuation unit 220.

<Second Actuation Unit 220>

In the present modification, the second actuation unit 220 receives information indicating the direction in which the signal light is received from the specification unit 140. Then, the second actuation unit 220 sets the next scanning range such that the direction in which the signal light is received, indicated by the received information, is the direction of the center of the next scanning range.

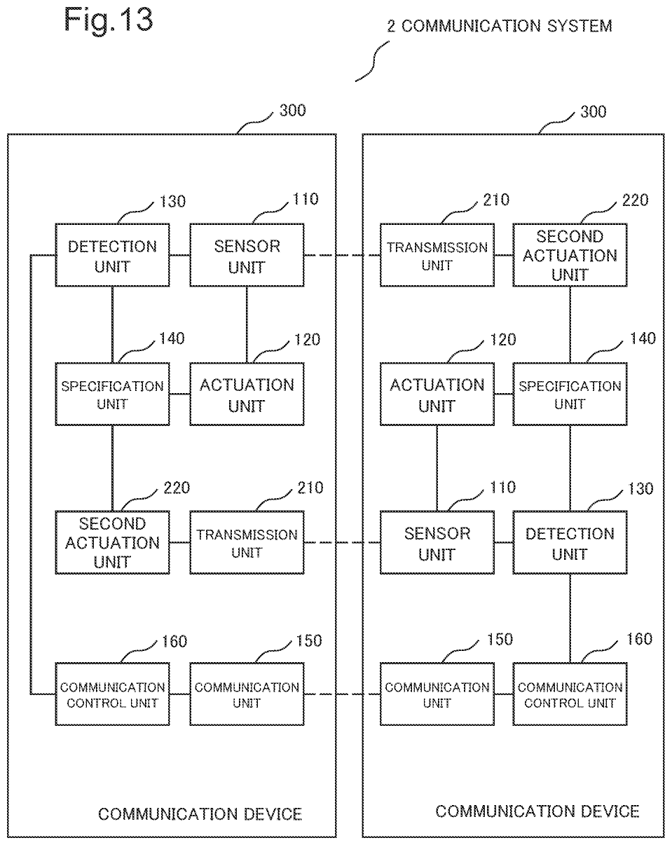

FIG. 13 is a block diagram illustrating an example of a configuration of a communication system 2 according to the second modification of the second example embodiment of the present disclosure. The configuration of the communication system 2 illustrated in FIG. 13 corresponds to a configuration in which the reception device 100 and the transmission device 200 of the communication system 1 illustrated in FIG. are replaced with two communication devices 300.

### Other Example Embodiments

The reception device 10, the reception device 100, the transmission device 200, and the communication device 300 described above can be achieved by a computer including a memory and a processor that executes a program loaded in the memory. The reception device 10, the reception device 100, the transmission device 200, and the communication device 300 described above can also be achieved by dedicated hardware. The reception device 10, the reception device 100, the transmission device 200, and the communication device 300 described above can also be achieved by a combination of the computer described above and dedicated hardware.

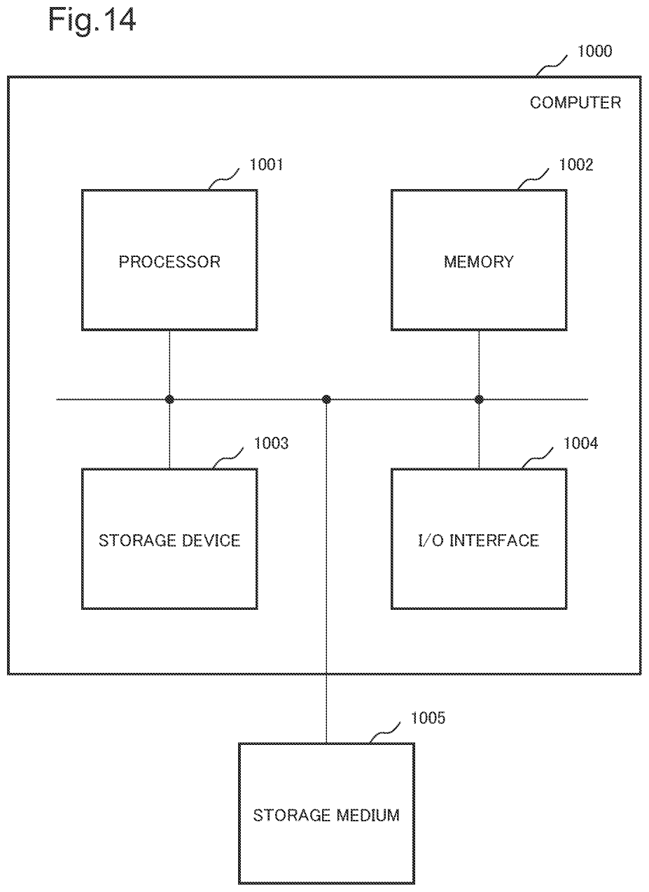

FIG. 14 is a diagram illustrating an example of a hardware configuration of a computer 1000 that can implement the reception device 10, the reception device 100, the transmission device 200, and the communication device 300 according to the example embodiment of the present disclosure. In the example of FIG. 14, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and in the memory 1002 and the storage device 1003. The processor 1001 can access, for example, other devices via the I/O interface 1004. The processor 1001 may access the storage medium 1005. The storage medium 1005 stores a program for operating the computer 1000 as a device (that is, the reception device 10, the reception device 100, the transmission device 200, or the communication device 300) according to the example embodiment of the present disclosure.

The processor 1001 loads a program, which is stored in the storage medium 1005 and causes the computer 1000 to operate as the device according to the example embodiments of the present disclosure, into the memory 1002. Then, when the processor 1001 executes the program loaded in the memory 1002, the computer 1000 operates as a device according to the example embodiments of the present disclosure.

The actuation unit 120, the detection unit 130, the specification unit 140, the communication unit 150, and the communication control unit 160 can be achieved by using, for example, the processor 1001 that executes a program loaded in the memory 1002. The second actuation unit 220, the communication unit 250, and the communication control unit 260 can be achieved by using, for example, the processor 1001 that executes a program loaded in the memory 1002.

Some or all of the sensor unit 110, the actuation unit 120, the detection unit 130, the specification unit 140, the communication unit 150, and the communication control unit 160 can be achieved by a dedicated circuit that achieves the function of each unit. Some or all of the transmission unit 210, the second actuation unit 220, the communication unit 250, and the communication control unit 260 can be implemented by dedicated circuits that implement the functions of the units.

In a case where optical communication is performed between artificial satellites, it is necessary to continuously apply beams having narrow divergence angles to each other between artificial satellites flying in space. For this purpose, a highly accurate capture and tracking system is required. Therefore, in general, for an artificial satellite that performs optical communication, a combination of an optical sensor having a wide field of view but low accuracy for capturing a signal transmitted from an artificial satellite of a communication partner in a wide range and an optical sensor having a narrow field of view but high accuracy for specifying a direction in which a signal is transmitted with high accuracy is used.

According to the technique disclosed in JP 2001-244893 A, a transmitted beam having a narrow divergence angle can be easily captured by a communication partner. However, it is necessary to mount a combination of an optical sensor having a wide field of view but low accuracy and an optical sensor having a narrow field of view but high accuracy in a device that receives and detects a beam transmitted from the communication device of JP 2001-244893 A. According to the technique disclosed in JP 2001-244893 A, it is not possible to achieve weight reduction and cost reduction of a device that receives a beam.

An example of an effect of the present disclosure is that weight reduction and cost reduction of a device for optical communication can be achieved.

Some or all of the above example embodiments may be described as the following supplementary notes, but are not limited to the following.

(Supplementary Note 1)

A reception device including:
a sensor configured to receive a signal from a detection range represented by a range of a detection direction;
an actuator configured to change the detection range in such a way that a search direction included in a search range wider than the detection range is included in the detection range for at least a predetermined time;
a detection unit configured to detect reception of the signal; and
a specification unit configured to specify a direction in which the signal is received.

(Supplementary Note 2)

The reception device according to Supplementary Note 1, wherein the actuator changes the detection range in such a way that the detection range matches each of a plurality of target ranges for at least the predetermined time, the plurality of target ranges being determined in such a way that a search direction included in the search range is included in at least one of the plurality of target ranges, the each of the plurality of target ranges having a same size same as a size of the detection range.

(Supplementary Note 3)

The reception device according to Supplementary Note 1, in which the actuator changes the detection range in such a way that a plane including a straight line in a starting point direction and a straight line in a detection direction rotates in a constant direction on an axis in the starting point direction while increasing a degree of angle between the starting point direction and the detection direction, the starting point direction being determined based on the search range, the detection direction being determined based on the detection range.

(Supplementary Note 4)

The reception device according to Supplementary Note 3, in which the actuator changes the detection direction in such a way that a magnitude of change of the detection direction is constant.

(Supplementary Note 5)

The reception device according to Supplementary Note 1, in which
the actuator changes the detection range in such a way that the detection rage matches each of a plurality of target ranges for at least the predetermined time, the plurality of target ranges being determined in such a way that a search direction included in a first search range that is a part of the search range is included in at least one of the plurality of target ranges, the each of the plurality of target ranges having a size same as a size of the detection range, and changes the detection range in a second search range in such a way that a plane including a straight line in a starting point direction and a straight line in a detection direction rotates in a constant direction on an axis is the starting point direction while increasing a degree of angle between the starting point direction and the detection direction, the second search range being included in the search range and not being included in the first search range, the starting point direction being determined based on the search range, the detection direction being determined based on the detection range.

(Supplementary Note 6)

A communication system including the reception device according to any one of Supplementary Notes 1 to 3, including
a transmission device including:

a transmitter configured to transmit a signal toward a transmission range of a predetermined size, the transmission range being represented by a range of a transmission direction; and
a second actuator configured to change the transmission range in such a way that a scan direction included in a scan range is included in the transmission range for at least a second predetermined time, the scan range being wider than the transmission range.

(Supplementary Note 7)

The communication system according to Supplementary Note 6, in which
the second predetermined time is longer than the predetermined time.

(Supplementary Note 8)

A communication device including:
a sensor configured to receive a signal from a detection range represented by a range of directions;
an actuator configured to change the detection range in such a way that a search direction included in a search range is included in the detection range for at least a predetermined time, the search range being wider than the detection range;
a specification unit configured to specify a direction in which the signal is received;
a transmitter configured to transmit a second signal toward a transmission range of a predetermined size, the transmission range being represented by a range of directions; and
a second actuator configured to change the transmission range in such a way that a scan direction included in a scan range is included in the transmission range for at least a predetermined second time, the scan range being wider than the transmission range.

(Supplementary Note 9)

A reception method including:
receiving a signal from a detection range represented by a range of a reception direction;
changing the detection range in such a way that a search direction included in a search range wider than the detection range is included in the detection range for at least a predetermined time;
detecting reception of the signal; and
specifying a reception direction in which the signal is received.

(Supplementary Note 10)

The reception method according to Supplementary Note 9, including:
changing the detection range in such a way that the detection range matches each of a plurality of target ranges for at least the predetermined time, the plurality of target ranges being determined in such a way that a search direction included in the search range is included in at least one of the plurality of target ranges, the each of the plurality of target ranges having a same size same as a size of the detection range.

(Supplementary Note 11)

The reception method according to Supplementary Note 9, including
changing the detection range in such a way that a plane including a straight line in a starting point direction and a straight line in a detection direction rotates in a constant direction on an axis in the starting point direction while increasing a degree of angle between the starting point direction and the detection direction, the starting point direction being determined based on the search range, the detection direction being determined based on the detection range.

(Supplementary Note 12)

The reception method according to Supplementary Note 11, including
changing the detection direction in such a way that a magnitude of change of the detection direction is constant.

(Supplementary Note 13)

The reception method according to Supplementary Note 9, including:
changing the detection range in such a way that the detection rage matches each of a plurality of target ranges for at least the predetermined time, the plurality of target ranges being determined in such a way that a search direction included in a first search range that is a part of the search range is included in at least one of the plurality of target ranges, the each of the plurality of target ranges having a size same as a size of the detection range; and
changing the detection range in a second search range in such a way that a plane including a straight line in a starting point direction and a straight line in a detection direction rotates in a constant direction on an axis in the starting point direction while increasing a degree of angle between the starting point direction d and the detection direction, the second search range being included in the search range and not being included in the first search range, the starting point direction being determined based on the search range, the detection direction being determined based on the detection range.

(Supplementary Note 14)

A communication method including the reception method according to any one of Supplementary Notes 9 to 11, including:
a transmission method including:
transmitting a signal toward a transmission range of a predetermined size, the transmission range being represented by a range of a transmission direction; and
changing the transmission range in such a way that a scan direction included in a scan range is included in the transmission range for at least a second predetermined time, the scan range being wider than the transmission range,
   wherein
the reception method is performed by a reception device, and
the transmission method is performed by a transmission device.

(Supplementary Note 15)

The communication method according to Supplementary Note 14, in which
the second predetermined time is longer than the predetermined time.

(Supplementary Note 16)

A communication method including:
receiving a signal from a detection range represented by a range of a detection direction;
changing the detection range in such a way that a search direction included in a search range is included in the detection range for at least a predetermined time, the search range being wider than the detection range;
specifying a reception direction in which the signal is received;
transmitting a second signal toward a transmission range of a predetermined size, the transmission range being represented by a range of a transmission direction; and
changing the transmission range in such a way that a scan direction included in a scan range is included in the transmission range for at least a predetermined second time, the scan range being wider than the transmission range.

(Supplementary Note 17)

A program for causing a computer to execute:
detection processing of detecting a sensor having received a signal from a detection range represented by a range of a detection direction;
actuation processing of changing the detection range in such a way that a search direction included in a search range is included in the detection range for at least a predetermined time, the search range being wider than the detection range; and
specification processing of specifying a reception direction in which the signal is received.

(Supplementary Note 18)

The program according to Supplementary Note 17, in which
the actuation processing changes the detection range in such a way that the detection range matches each of a plurality of target ranges for at least the predetermined time, the plurality of target ranges being determined in such a way that a search direction included in the search range is included in at least one of the plurality of target ranges, the each of the plurality of target ranges having a same size same as a size of the detection range.

(Supplementary Note 19)

The program according to Supplementary Note 17, wherein
the actuation processing changes the detection range in such a way that a plane including a straight line in a starting point direction and a straight line in a detection direction rotates in a constant direction on an axis in the starting point direction while increasing a degree of angle between the starting point direction and the detection direction, the starting point direction being determined based on the search range, the detection direction being determined based on the detection range.

(Supplementary Note 20)

The program according to Supplementary Note 19, wherein
the actuation processing changes the detection direction in such a way that a magnitude of change of the detection direction is constant.

(Supplementary Note 21)

The program according to Supplementary Note 17, wherein
the actuation processing changes the detection range in such a way that the detection rage matches each of a plurality of target ranges for at least the predetermined time, the plurality of target ranges being determined in such a way that a search direction included in a first search range that is a part of the search range is included in at least one of the plurality of target ranges, the each of the plurality of target ranges having a size same as a size of the detection range, and changes the detection range in a second search range in such a way that a plane including a straight line in a starting point direction and a straight line in a detection direction rotates in a constant direction on an axis in the starting point direction while increasing a degree of angle between the starting point direction and the detection direction, the second search range being included in the search range and not being included in the first search range, the starting point direction being determined based on the search range, the detection direction being determined based on the detection range.

(Supplementary Note 22)

A program causing a computer to execute:
specification processing of specifying a direction in which a sensor receives a signal from a detection range represented by a range of a reception direction;
actuation processing of changing the detection range in such a way that a search direction included in a search range is included in the detection range for at least a predetermined time, the search range being wider than the detection range;
transmission processing of transmitting a second signal toward a transmission range of a predetermined size, the transmission range being represented by a range of a transmission direction; and
second actuation processing of changing the transmission range in such a way that a scan direction included in a scan range wider than the transmission range is included in the transmission range for at least a second predetermined time, the scan range being wider than the transmission range.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

### REFERENCE SIGNS LIST

1 communication system
2 communication system
10 reception device
100 reception device
110 sensor unit
120 actuation unit
130 detection unit
140 specification unit
150 communication unit
160 communication control unit
200 transmission device
210 transmission unit
220 second actuation unit
250 communication unit
260 communication control unit
300 communication device
1000 computer
1001 processor
1002 memory
1003 storage device
1004 I/O interface
1005 storage medium

What is claimed is:

1. A reception device comprising:
a sensor configured to receive a signal from a detection range represented by a range of a reception direction;
an actuator configured to change the detection range in such a way that a search direction included in a search range wider than the detection range is included in the detection range for at least a predetermined time;
at least one memory storing a set of instructions; and
at least one processor configured to execute the set of instructions to:
detect reception of the signal; and
specify a reception direction in which the signal is received.

2. The reception device according to claim 1, wherein
the actuator changes the detection range in such a way that the detection range matches each of a plurality of target ranges for at least the predetermined time, the plurality of target ranges being determined in such a way that a search direction included in the search range is included in at least one of the plurality of target ranges, the each of the plurality of target ranges having a same size same as a size of the detection range.

3. The reception device according to claim 1, wherein
the actuator changes the detection range in such a way that a plane including a straight line in a starting point direction and a straight line in a detection direction rotates in a constant direction on an axis in the starting point direction while increasing a degree of angle between the starting point direction and the detection direction, the starting point direction being determined based on the search range, the detection direction being determined based on the detection range.

4. The reception device according to claim 3, wherein
the actuator changes the detection direction in such a way that a magnitude of change of the detection direction is constant.

5. The reception device according to claim 1, wherein
the actuator changes the detection range in such a way that the detection rage matches each of a plurality of target ranges for at least the predetermined time, the plurality of target ranges being determined in such a way that a search direction included in a first search range that is a part of the search range is included in at least one of the plurality of target ranges, the each of the plurality of target ranges having a size same as a size of the detection range, and changes the detection range in a second search range in such a way that a plane including a straight line in a starting point direction and a straight line in a detection direction rotates in a constant direction on an axis in the starting point direction while increasing a degree of angle between the starting point direction and the detection direction, the second search range being included in the search range and not being included in the first search range, the starting point direction being determined based on the search range, the detection direction being determined based on the detection range.

6. A communication system including the reception device according to claim 1, comprising
a transmission device comprising:
a transmitter configured to transmit a signal toward a transmission range of a predetermined size, the transmission range being represented by a range of a transmission direction; and
a second actuator configured to change the transmission range in such a way that a scan direction included in a scan range is included in the transmission range for at least a second predetermined time, the scan range being wider than the transmission range.

7. The communication system according to claim 6, wherein
the second predetermined time is longer than the predetermined time.

8. A communication device comprising:
a sensor configured to receive a signal from a detection range represented by a range of a detection direction;
an actuator configured to change the detection range in such a way that a search direction included in a search range is included in the detection range for at least a predetermined time, the search range being wider than the detection range;
at least one memory storing a set of instructions;
at least one processor configured to execute the set of instructions to specify a reception direction in which the signal is received;
a transmitter configured to transmit a second signal toward a transmission range of a predetermined size, the transmission range represented by a range of transmission direction; and
a second actuator configured to change the transmission range in such a way that a scan direction included in a scan range is included in the transmission range for at least a second predetermined time, the scan range being wider than the transmission range.

9. A reception method comprising:
receiving a signal from a detection range represented by a range of a reception direction;
changing the detection range in such a way that a search direction included in a search range wider than the detection range is included in the detection range for at least a predetermined time;
detecting reception of the signal; and
specifying a reception direction in which the signal is received.

10. The reception method according to claim 9, comprising
changing the detection range in such a way that the detection range becomes each of a plurality of target ranges, the plurality of target ranges being determined in such a way that a search direction included in the search range is included in at least one of the plurality of target ranges, the each of the plurality of target ranges having a same size same as a size of the detection range.

11. The reception method according to claim 9, comprising
changing the detection range in such a way that a plane including a straight line in a starting point direction and a straight line in a detection direction rotates in a constant direction on an axis is the starting point direction while increasing a degree of angle between the starting point direction and the detection direction, the starting point direction being determined based on the search range, the detection direction being determined based on the detection range.

12. The reception method according to claim 11, comprising
changing the detection direction in such a way that a magnitude of change of the detection direction is constant.

13. The reception method according to claim 9, comprising:
changing the detection range in such a way that the detection rage becomes each of a plurality of target ranges for at least the predetermined time, the plurality of target ranges being determined in such a way that a search direction included in a first search range that is a part of the search range is included in at least one of the plurality of target ranges, the each of the plurality of target ranges having a size same as a size of the detection range; and
changing the detection range in a second search range in such a way that a plane including a straight line in a starting point direction and a straight line in a detection direction rotates in a constant direction on an axis in the starting point direction while increasing a degree of angle between the starting point direction and the detection direction, the second search range being included in the search range and not being included in the first search range, the starting point direction being determined based on the search range, the detection direction being determined based on the detection range.

14. A communication method including the reception method according to claim 9, the communication method comprising:
a transmission method comprising:
transmitting a signal toward a transmission range of a predetermined size, the transmission range being represented by a range of a transmission direction; and
changing the transmission range in such a way that a scan direction included in a scan range is included in the transmission range for at least a second predetermined time, the scan range being wider than the transmission range.

15. The communication method according to claim 14, wherein
the second predetermined time is longer than the predetermined time.
